(19) United States
(12) Patent Application Publication
(10) Pub. No.: US 2010/0247063 A1
(43) Pub. Date: Sep. 30, 2010

(54) MOVING IMAGE RECORDING/REPRODUCING APPARATUS, MOVING IMAGE RECORDING/REPRODUCING METHOD, AND COMPUTER READABLE RECORDING MEDIUM HAVING MOVING IMAGE RECORDING/REPRODUCING PROGRAM RECORDED THEREON

(75) Inventors: Kenji Matsuhara, Hyogo-ken (JP); Hiroaki Kubo, Kyoto (JP); Nobuhiro Mishima, Osaka (JP); Kazuo Inui, Hyogo-ken (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku, Tokyo (JP)

(21) Appl. No.: 12/742,942

(22) PCT Filed: Aug. 17, 2009
(86) PCT No.: PCT/JP2009/003906

§ 371 Date: May 14, 2010

(30) Foreign Application Priority Data
Sep. 16, 2008 (JP) 2008-237023

(51) Int. Cl. H04N 5/93; G06F 3/12

(52) U.S. Cl. 386/52; 358/1.13; 386/E05.001

(57) ABSTRACT

In order to facilitate editing of moving images, MFP includes a reproduction portion to reproduce a moving image, an insertion location determination portion to determine, as an insertion location, a reproduction location of a first moving image that is being reproduced at a point of time when an insertion instruction is accepted during reproduction of the first moving image by the reproduction portion, a still image obtaining portion to obtain a still image, a moving image generation portion to generate a second moving image displaying the obtained still image, and a combination portion to generate a third moving image in which the second moving image is inserted at the determined insertion location of the first moving image (S09) and to store the generated third moving image in HDD.

### TECHNICAL FIELD

The present invention relates to a moving image recording/reproducing apparatus, a moving image recording/reproducing method, and a moving image recording/reproducing program, and more particularly to a moving image recording/reproducing apparatus, a moving image recording/reproducing method, and a computer readable recording medium having a moving image recording/reproducing program recorded thereon for editing moving images.

### BACKGROUND ART

In recent years, Multi Function Peripherals (referred to as “MFP” hereinafter) are equipped with mass storage devices such as hard disk drives (HDD) to be able to store a large amount of data. Therefore, in addition to still images, moving images having a relatively large data size can be stored.

In Japanese Laid-Open Patent Publication No. 2002-368984 (Patent Document 1), an image processing apparatus for scanning and displaying a printed material on which image information and additional information different from the image information are printed includes separation means for separating said additional information in the image information obtained by scanning and reproduction means for reproducing the additional information separated by the separation means in combination with the scanned image.

The conventional image processing apparatus, however, is intended to reproduce the moving image specified by the additional information in combination with the display of the scanned still image, and cannot edit the moving image. In order to edit moving images, an application program for editing moving images has to be installed, and the editing operation is thus cumbersome.

### Patent Document

Japanese Laid-Open Patent Publication No. 2002-368984

### DISCLOSURE OF THE INVENTION

### Problems to be Solved by the Invention

The present invention is made to solve the aforementioned problem. An object of the present invention is to provide a moving image recording/reproducing apparatus capable of easily editing moving images.

Another object of the present invention is to provide a moving image recording/reproducing method capable of easily editing moving images.

A further object of the present invention is to provide a computer readable recording medium having a moving image recording/reproducing program recorded thereon, capable of easily editing moving images.

### Means for Solving the Problems

In order to achieve the aforementioned object, in accordance with an aspect of the present invention, a moving image recording/reproducing apparatus includes: a reproduction portion to reproduce a moving image; an insertion location determination portion to determine, as an insertion location, a reproduction location of a first moving image that is being reproduced at a point of time when a prescribed instruction is accepted during reproduction of the first moving image by the reproduction portion; a still image obtaining portion to obtain a still image; a moving image generation portion to generate a second moving image displaying the obtained still image; a combination portion to generate a third moving image in which the second moving image is inserted at the determined insertion location of the first moving image; and a storage portion to store the generated third moving image.

In accordance with another aspect of the present invention, an image recording/reproducing apparatus includes: an insertion location determination portion to determine, as an insertion location, a reproduction location of a first moving image that is being reproduced at a point of time when a prescribed instruction is accepted during reproduction of the first moving image by the reproduction portion; a still image obtaining portion to obtain a still image; a moving image generation portion to generate a second moving image displaying the obtained still image; and a storage portion to store the second moving image in association with the insertion location of the first moving image.

In accordance with yet another aspect of the present invention, a moving image recording/reproducing method includes the steps of: reproducing a moving image; determining, as an insertion location, a reproduction location of a first moving image that is being reproduced at a point of time when a prescribed instruction is accepted during reproduction of the first moving image in the step of reproducing; obtaining a still image; generating a second moving image displaying the obtained still image; converting the first moving image into a third moving image in which the second moving image is inserted at the determined insertion location; and storing the third moving image.

In accordance with a further aspect of the present invention, a moving image recording/reproducing method includes the steps of: reproducing a moving image; determining, as an insertion location, a reproduction location of a first moving image that is being reproduced at a point of time when a prescribed instruction is accepted during reproduction of the first moving image in the step of reproducing; obtaining a still image; generating a second moving image displaying the obtained still image; and storing the second moving image in association with the insertion location of the first moving image.

In accordance with a still further aspect of the present invention, a computer readable recording medium having a moving image recording/reproducing program recorded thereon allows a computer to execute the steps of: reproducing a moving image; determining, as an insertion location, a reproduction location of a first moving image that is being reproduced at a point of time when a prescribed instruction is accepted during reproduction of the first moving image in the step of reproducing; obtaining a still image; generating a second moving image displaying the obtained still image; converting the first moving image into a third moving image in which the second moving image is inserted at the determined insertion location; and storing the third moving image.

In accordance with a still further aspect of the present invention, a computer readable recording medium having a moving image recording/reproducing program recorded thereon allows a computer to execute the steps of: reproducing a moving image; determining, as an insertion location, a reproduction location of a first moving image that is being reproduced at a point of time when a prescribed instruction is accepted during reproduction of the first moving image in the step of reproducing; obtaining a still image; generating a second moving image displaying the obtained still image; and storing the second moving image in association with the insertion location of the first moving image.

### BRIEF DESCRIPTION OF THE DRAWINGS

FIG. 1 is a diagram showing an overview of a moving image recording/reproducing system in an embodiment of the present invention.

FIG. 2 is a perspective view showing an external view of MFP.

FIG. 3 is a block diagram showing an exemplary hardware configuration of MFP.

FIG. 4 is a functional block diagram showing an example of functions of CPU of MFP together with data stored in HDD.

FIG. 5 is a flowchart showing an exemplary flow of a moving image recording process.

FIG. 6 is a functional block diagram showing an example of functions of CPU of MFP together with data stored in HDD in a modified embodiment.

FIG. 7A is a first diagram illustrating switching of reproduction between a first moving image and a second moving image.

FIG. 7B is a second diagram illustrating switching of reproduction between a first moving image and a second moving image.

FIG. 7C is a third diagram illustrating switching of reproduction between a first moving image and a second moving image.

FIG. 8 is a flowchart showing an exemplary flow of a moving image recording process in a modified embodiment.

FIG. 9 is a flowchart showing an exemplary flow of a moving image reproduction process.

### BEST MODES FOR CARRYING OUT THE INVENTION

In the following, an embodiment of the present invention will be described with reference to the figures. In the following description, the same parts are denoted with the same reference numerals. Their designations and functions are also the same. Therefore, a detailed description thereof will not be repeated.

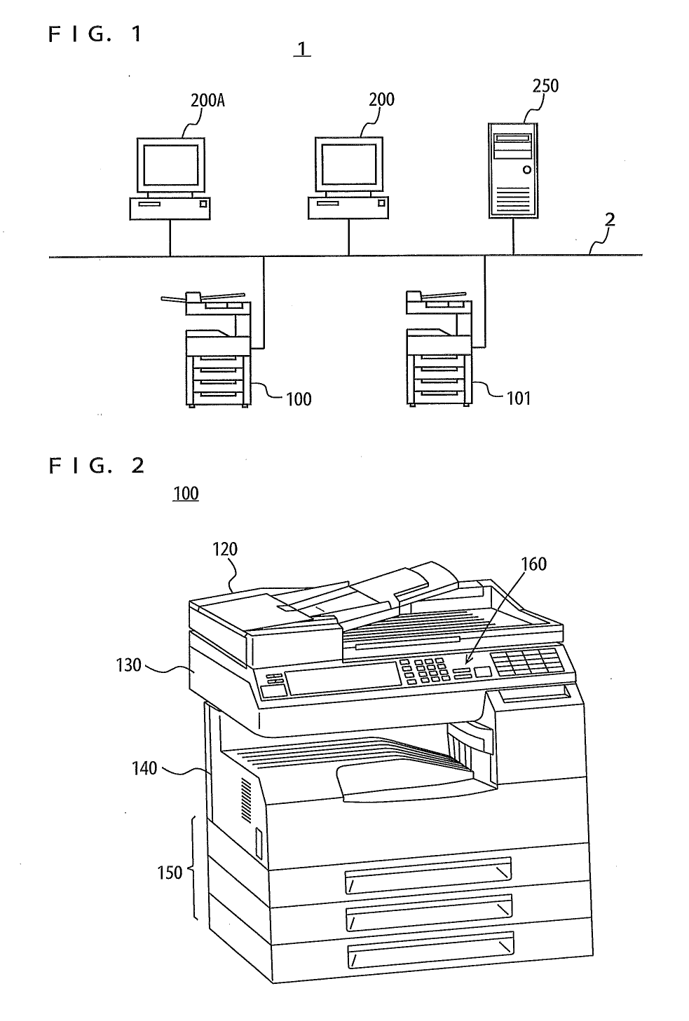

FIG. 1 is a diagram showing an overview of a moving image recording/reproducing system in an embodiment of the present invention. Referring to FIG. 1, a moving image recording/reproducing system 1 includes MFP (Multi Function Peripheral) 100, 101 each functioning as a moving image recording/reproducing apparatus, personal computers (referred to as “PC” hereinafter) 200, 200A, and a file server 250, each of which is connected to a network 2.

Network 2 is a local area network (LAN) and is connected with the Internet through a gateway. The form of connection of network 2 can be wired or wireless. Furthermore, network 2 is not limited to a LAN and can be a network using a Public Switched Telephone Network, a wide area network (WAN), the Internet, and so on.

PC 200, 200A and file server 250 are general computers. Their hardware configurations and functions are well known and therefore a description thereof will not be repeated here. A moving image reproduction program is installed in each of PC 200, 200A for decoding the encoded moving images and reproducing the moving images. File server 250 includes a storage device for storing moving images and stores moving images received from either MFP 100, 101 or PC 200, 200A upon request thereof or transmits moving images stored in the storage device.

MFP 100, 101 have the same configuration and function and therefore MFP 100 will be taken an example in the following description unless otherwise specified. MFP 100 includes a scanner for scanning documents, an image forming device for forming an image on a recording medium such as paper based on image data, and a facsimile machine, and has an image scanning function, a copy function, and a facsimile transmission/reception function.

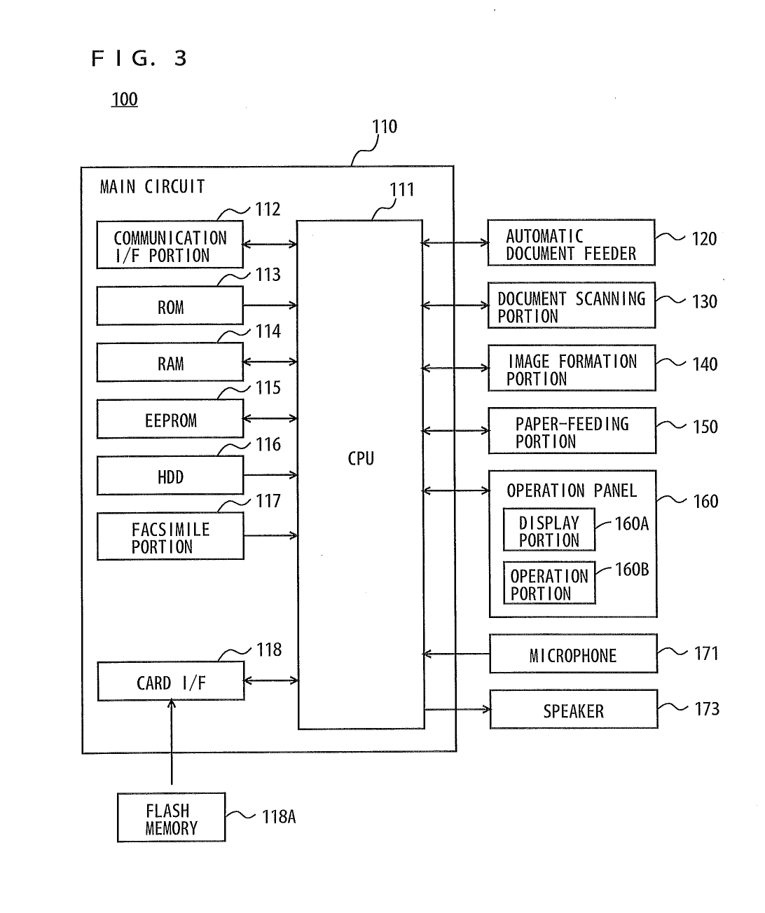

FIG. 2 is a perspective view showing an external view of MFP. FIG. 3 is a block diagram showing an exemplary hardware configuration of MFP. Referring to FIG. 2 and FIG. 3, MFP 100 includes a main circuit 110, a document scanning portion 130 for scanning a document, an automatic document feeder 120 for transferring a document to document scanning portion 130, an image formation portion 140 for forming on paper and the like a still image output by document scanning portion 130 scanning a document, a paper-feeding portion 150 for supplying paper to image formation portion 140, an operation panel 160 as a user interface, a microphone 171 receiving input of sounds, and a speaker 173 outputting sounds. Main circuit 110 includes a CPU 111, a communication interface (I/F) portion 112, a ROM 113, a RAM 114, an EEPROM (Electronically Erasable and Programmable ROM) 115, a hard disk drive (HDD) 116 as a mass storage device, a facsimile portion 117, and a card interface (I/F) 118 to which a flash memory 118A is attached. CPU 111 is connected to automatic document feeder 120, document scanning portion 130, image formation portion 140, paper-feeding portion 150, operation panel 160, microphone 171, and speaker 173 to control MFP 100 as a whole.

ROM 113 stores a program executed by CPU 111 or data necessary to execute the program. RAM 114 is used as a work area when CPU 111 executes a program. RAM 114 also temporarily stores still images successively sent from document scanning portion 130.

Operation panel 160 is provided on the top face of MFP 100 and includes a display portion 160A and an operation portion 160B. Display portion 160A is a display device such as a liquid crystal display (LCD), an organic ELD (Electroluminescence Display) and displays instruction menus for the user, information concerning the obtained image data, and the like. Operation portion 160B includes a plurality of keys and accepts inputs of data such as instructions, characters, and numerals through the user's operations corresponding to the keys. Operation portion 160B further includes a touch-panel provided on display portion 160A.

Communication I/F portion 112 is an interface for connecting MFP 100 to network 2. CPU 111 communicates with MFP 100, 101, PC 200, 200A, or server 250 through communication I/F portion 112 to transmit/receive data. Communication I/F portion 112 can also communicate with a computer connected to the Internet via network 2. Furthermore, communication I/F portion 112 transmits/receives emails to/from PC.

Facsimile portion 117 is connected to a Public Switched Telephone Network (PSTN) to transmit facsimile data to PSTN or receive facsimile data from PSTN. Facsimile portion 117 stores the received facsimile data into HDD 116 or outputs the same to image formation portion 140. Image formation portion 140 prints the facsimile data received by facsimile portion 117 on a sheet of paper. In addition, facsimile portion 117 converts the data stored in HDD 116 into facsimile data and transmits the converted data to a facsimile machine connected to PSTN.

Flash memory 118A is attached to card I/F 118. CPU 111 can access flash memory 118A through card I/F 118. CPU 111 loads a program recorded on flash memory 118A attached to card I/F 118, into RAM 114 for execution. It is noted that the program executed by CPU 111 is not limited to a program stored in flash memory 118A, and a program stored in HDD 116 may be loaded into RAM 114 for execution. In this case, another computer connected to network 2 may overwrite the program stored in HDD 116 of MFP 100 or may additionally write a new program. Furthermore, MFP 100 may download a program from another computer connected to network 2 and store the program into HDD 116. The program referred to herein includes not only a program directly executable by CPU 111 but also a source program, a compressed program, an encrypted program, and the like.

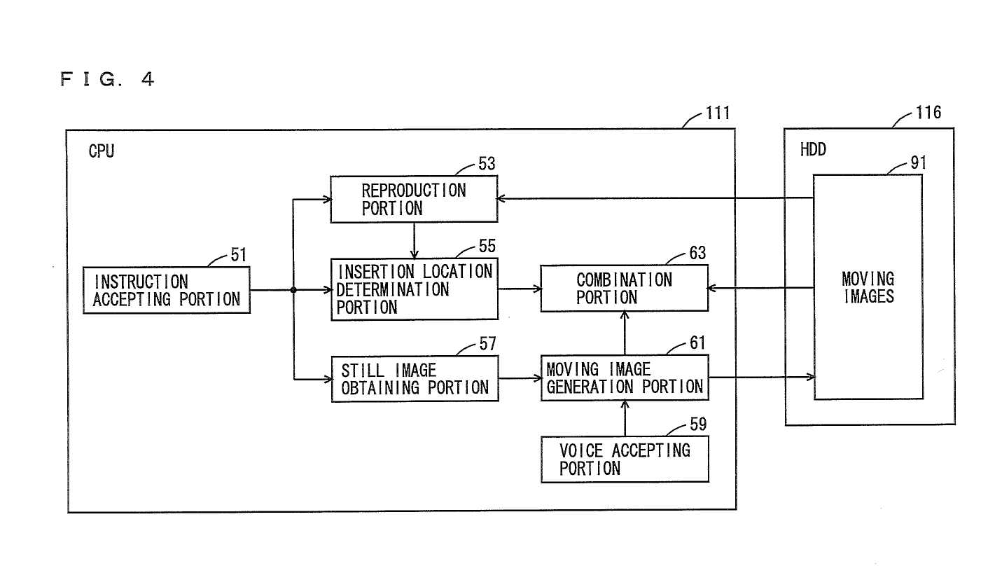

FIG. 4 is a functional block diagram showing an example of functions of CPU of MFP together with data stored in HDD. Referring to FIG. 4, CPU 111 of MFP 100 includes an instruction accepting portion 51 accepting an instruction by the user, a reproduction portion 53 reproducing a moving image, an insertion location determination portion 55 determining any given location in a moving image as an insertion location, a still image obtaining portion 57 for obtaining a still image, a voice accepting portion 59 accepting voice, a moving image generation portion 61 generating a moving image from still images, and a combination portion 63 combining two moving images together.

A plurality of moving images 91 are stored beforehand in HDD 116. A plurality of moving images 91 are here moving images displayed at a time of presentation in meetings or the like.

Instruction accepting portion 51 accepts an instruction input by the user who operates MFP 100. Instruction accepting portion 51 accepts an instruction input to operation portion 160B by the user or an instruction input to microphone 171 by voice. When an instruction is input to operation portion 160B, instruction accepting portion 51 accepts the instruction from operation portion 160B. When voice is input to microphone 171, instruction accepting portion 51 accepts, as an instruction, a text obtained by performing voice recognition on the voice.

When accepting a reproduction instruction input to operation portion 160B or microphone 171 by the user, instruction accepting portion 51 outputs the accepted reproduction instruction to reproduction portion 53. The reproduction instruction is a command for designating reproduction of any one of a plurality of moving images 91 stored in HDD 116 and includes moving image identification information for identifying one of a plurality of moving images 91 stored in HDD 116. For example, a list screen appears on display portion 160A to display the respective moving image identification information for identifying a plurality of moving images 91 stored in HDD 116 so that the user specifies one of a plurality of moving images 91 from the displayed list screen.

Reproduction portion 53 receives the reproduction instruction from instruction accepting portion 51 to read from HDD 116 and reproduce moving image 91 specified by the moving image identification information included in the reproduction instruction. If moving image 91 is compressed data, reproduction portion 53 decodes the compressed data. Furthermore, reproduction portion 53 displays the reproduced moving image on display portion 160A. Here, moving image 91 reproduced by reproduction portion 53 in accordance with the reproduction instruction is called a first moving image.

When the user inputs an insertion instruction to operation portion 160B, instruction accepting portion 51 accepts the insertion instruction and outputs the accepted insertion instruction to insertion location determination portion 55. The insertion instruction is a command to give an instruction to insert a second moving image into the first moving image reproduced by reproduction portion 53.

If the insertion instruction is accepted from instruction accepting portion 51 when reproduction portion 53 is reproducing the first moving image, insertion location determination portion 55 determines, as an insertion location, the location in the first moving image at a point of time when the insertion instruction is accepted, and then outputs to combination portion 63 the determined insertion location and the moving image identification information for identifying the first moving image reproduced by reproduction portion 53. Here, a location in a moving image is, for example, a reproduction time that is an elapsed time since reproduction of the moving image was started.

When the insertion instruction is accepted by instruction accepting portion 51, reproduction portion 53 may pause the reproduction of the first moving image or may continue the reproduction.

Still image obtaining portion 57 obtains a still image and outputs the obtained still image to moving image generation portion 61. When the user inputs a document scanning instruction to operation portion 160B for scanning a document image, still image obtaining portion 57 receives the document scanning instruction from operation portion 160B. When the document scanning instruction is input, still image obtaining portion 57 allows document scanning portion 130 to scan a document image and obtains from document scanning portion 130 the still image output by document scanning portion 130 scanning the document image. When document scanning portion 130 scans a document having multiple sheets, still image obtaining portion 57 obtains a plurality of still images and outputs the obtained plurality of still images to moving image generation portion 61.

Furthermore, still image obtaining portion 57 displays the file names of still images stored in file server 250 or HDD 116. When the user inputs an instruction to operation portion 160B to select from the displayed file names, still image obtaining portion 57 receives the selected file name from operation portion 160B. Still image obtaining portion 57 reads the still image specified by the selected file name from HDD 116 or obtains the same from file server 250 and outputs the still image to moving image generation portion 61. The still images stored in HDD 116 or file server 250 include a still image output by document scanning portion 130 scanning a document, print data received by communication I/F portion 112 from PC 200, 200A connected to network 2, or a still image received by communication I/F portion 112 from PC 200, 200A or MFP 101 connected to network 2 using a communication protocol such as, for example, FTP (File Transfer Protocol) or SMB (Server Message Block).

Voice accepting portion 59 accepts voice input to microphone 171 and outputs the accepted voice to moving image generation portion 61.

Moving image generation portion 61 displays the still image input from still image obtaining portion 57 for a prescribed time and in addition, generates a second moving image including the voice input from voice accepting portion 59. When a plurality of still images are input from still image obtaining portion 57, moving image generation portion 61 generates the second moving image in such a manner that a plurality of still images are sequentially displayed, that is, in the form of so-called slideshow. Moving image generation portion 61 outputs the generated second moving image to combination portion 63.

When the insertion location is input from insertion location determination portion 55, combination portion 63 combines the first moving image reproduced by reproduction portion 53 with the second moving image input from moving image generation portion 61. Specifically, a third moving image is generated in which the second moving image input from moving image generation portion 61 is inserted into the first moving image reproduced by reproduction portion 53 at the insertion location thereof. Combination portion 63 stores the generated third moving image in HDD 116. The third moving image is stored as a new moving image 83 in HDD 116.

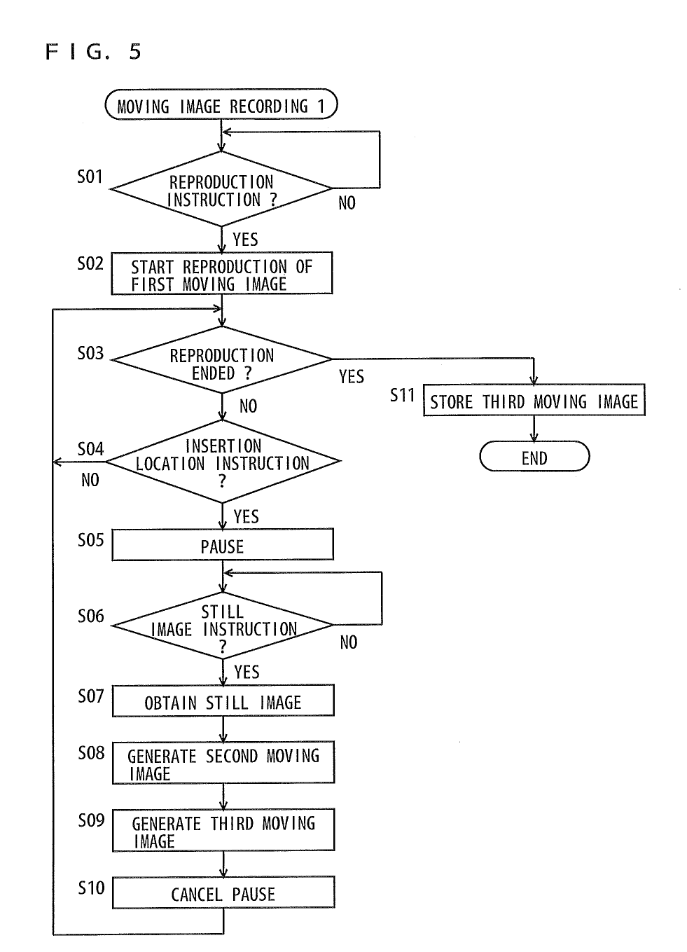

FIG. 5 is a flowchart showing an exemplary flow of a moving image recording process. The moving image recording process is a process executed by CPU when CPU 111 of MFP 100 executes a moving image recording/reproducing program. Referring to FIG. 5, CPU 111 determines whether a reproduction instruction is accepted or not (step S01). The reproduction instruction input to operation portion 160B by the user is accepted. The process waits until a reproduction instruction is accepted (step S01). If a reproduction instruction is accepted, the process proceeds to step S02. In other words, the moving image recording process is a process executed on condition that moving image 91 is reproduced. A list screen is displayed on display portion 160A to display the respective moving image identification information of a plurality of moving images 91 stored in HDD 116, and when the user inputs an operation to operation portion 160B to select one of the moving image identification information from the displayed list screen, the reproduction instruction is accepted. The reproduction instruction includes the moving image identification information of moving image 91 selected by the user among a plurality of moving images 91 stored in HDD 116. Here, moving image 91 selected by the user is called the first moving image. It is noted that the first moving image selected by the user is not limited to moving image 91 stored in HDD 116 and may be a moving image stored in file server 250.

In step S02, the first moving image specified by the moving image identification information included in the reproduction instruction accepted in step S01 is read among from moving images 91 stored in HDD 116 and starts to be reproduced. Then, it is determined whether the reproduction of the first moving image is ended or not. If the reproduction is ended, the process proceeds to step S11. If not, the process proceeds to step S04.

In step S04, it is determined whether the insertion instruction is accepted or not. If the insertion instruction is accepted, the process proceeds to step S05. If not, the process returns to step S03. In step S05, the reproduction of the first moving image is paused. Then, the process waits until an instruction for a still image is accepted (NO in step S06). If an instruction for a still image is accepted, the process proceeds to step S07.

In step S07, a still image is obtained. When the user inputs to operation portion 160B a document scanning instruction to scan a document image, document scanning portion 130 scans a document image so that a still image output by document scanning portion 130 scanning the document image is obtained. On the other hand, when the file names of still images stored in file server 250 or HDD 116 are displayed to allow the user to input an instruction to operation portion 160B to select from among the displayed file names, the still image specified by the selected file name is read from HDD 116 or received from file server 250 and is thus obtained.

In step S08, the still image obtained in step S07 is displayed for a prescribed time, and in addition, the second moving image including voice input to microphone 171 is generated. If a plurality of still images are input in step S07, the second moving image is generated in such a manner that a plurality of still images are sequentially displayed, that is, in the form of so-called slideshow.

In step S09, the third moving image is generated by combining the first moving image stored in HDD 116 with the second moving image generated in step S08. Specifically, the third moving image is generated in which the second moving image is inserted at a location (insertion location) where the first moving image is paused. If a plurality of insertion locations are designated in step S04 and the processes in step S05-step S10 are executed multiple times, then in step S09 executed for the second and subsequent times, the second moving image is inserted at that location of the third moving image generated most recently which corresponds to the location (insertion location) where the first moving image is paused.

Then, in step S05, the pause is cancelled, and the reproduction of the first moving image of which reproduction has been paused is resumed. The process then returns to step S03. In step S11, the third moving image generated in step S09 is stored in HDD 116. The process then ends.

Accordingly, when the third moving image is reproduced, the moving image in which the second moving image is inserted at the insertion location of the first moving image is reproduced.

<Modified Embodiment>

MFP 100 in the foregoing embodiment generates the third moving image by combining the first moving image with the second moving image. MFP 100A in a modified embodiment stores the second moving image in association with the insertion location of the first moving image. The difference between MFP 100A in the modified embodiment and MFP 100 as described above will be described below.

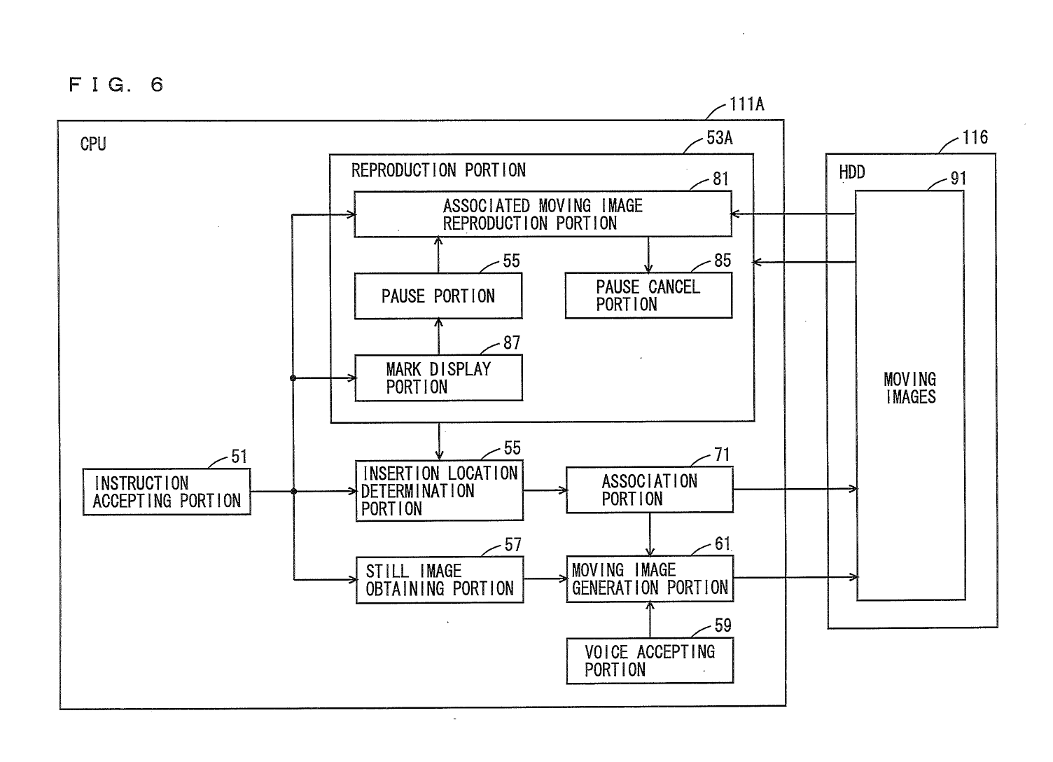

FIG. 6 is a functional block diagram showing an example of functions of CPU of MFP in the modified embodiment together with data stored in HDD. Referring to FIG. 6, the difference from the functional block diagram shown in FIG. 4 is in that reproduction portion 53A is modified and combination portion 63 is replaced with an association portion 71. The other functions are the same and therefore a description thereof will not be repeated here.

Referring to FIG. 6, association portion 71 receives an insertion location from insertion location determination portion 55 and then stores the second moving image input from moving image generation portion 61 into HDD 116 in association with the insertion location of the first moving image reproduced by reproduction portion 53. Accordingly, the second moving image is stored as moving image 91 in HDD 116 and in addition, the second moving image is associated with the insertion location of the first moving image. The second moving image may be associated with the insertion location of the first moving image by adding the insertion location and the moving image identification information for identifying the second moving image to the header portion of the first moving image, or by generating association data including the moving image identification information of the first moving image, the insertion location, and the moving image identification information of the second moving image and storing the association data in HDD 116. The description here will be made to the case where the insertion location and the moving image identification information of the second moving image are added to the header portion of the first moving image. In this case, the insertion location is the reproduction time of the first moving image.

Reproduction portion 53A includes an associated moving image reproduction portion 81, a pause portion 83, a pause cancel portion 85, and a mark display portion 87. Reproduction portion 53A receives a reproduction instruction from instruction accepting portion 51 to read moving image 91 specified by the moving image identification information included in the reproduction instruction from HDD 116 for reproduction. If moving image 91 is compressed data, reproduction portion 53A decodes the compressed data. Furthermore, reproduction portion 53A displays the reproduced moving image on display portion 160A. Here, moving image 91 reproduced by reproduction portion 53A in accordance with the reproduction instruction is referred to as the first moving image.

If the first moving image that is now being reproduced is associated with the second moving image, mark display portion 87 displays a prescribed mark when the first moving image is reproduced a prescribed time before the insertion location. Whether the first moving image is associated with the second moving image or not is determined by whether the insertion location and the moving image identification information of the second moving image are added to the header portion of the first moving image. A prescribed mark is to notify the user of the presence of the second moving image and may be graphics or a character. Mark display portion 87 accepts a display instruction input to operation portion 160B by the user. If the display instruction is accepted before the insertion location of the first moving image is reproduced after a prescribed mark is displayed, mark display portion 87 outputs a pause instruction to pause portion 83. Otherwise, nothing is output to pause portion 83.

If a pause instruction is input from mark display portion 87, in other words, if a display instruction is input by the user before the insertion location of the first moving image is reproduced after a prescribed mark is displayed, pause portion 83 pauses the reproduction of the first moving image when the insertion location of the first moving image is reproduced. When the reproduction of the first moving image is paused, pause portion 83 outputs a signal indicating the pause to associated moving image reproduction portion 81.

Associated moving image reproduction portion 81 receives the signal indicating the pause from pause portion 83 to read the second moving image from HDD 116 for reproduction. Then, when the reproduction of the second moving image is ended, a signal indicating that the reproduction is ended is output to pause cancel portion 85.

Pause cancel portion 85 receives the signal indicating the reproduction is ended from associated moving image reproduction portion 81 and then resumes the reproduction of the first moving image that has been paused by pause portion 83, in order to cancel the pause.

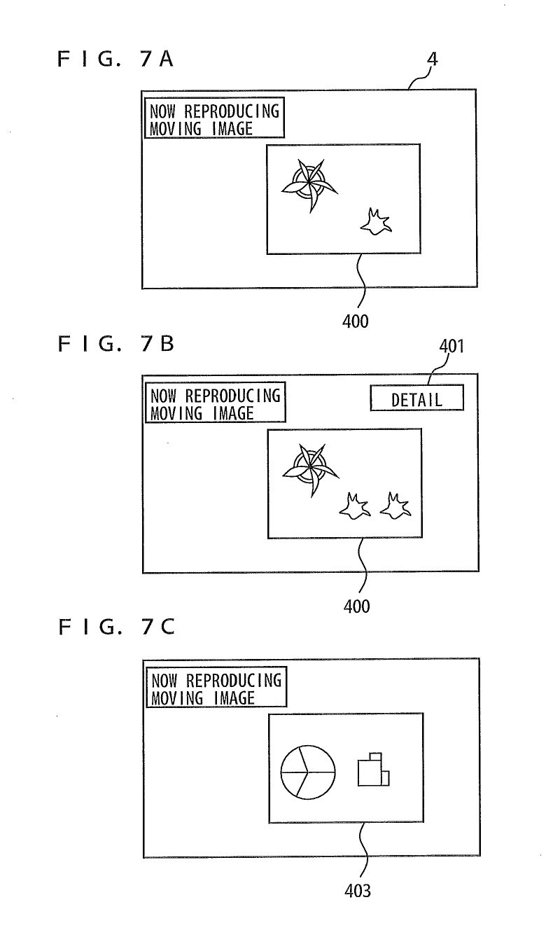

FIG. 7A-FIG. 7C are diagrams for illustrating switching of reproduction between the first moving image and the second moving image. FIG. 7A shows a state in which a first moving image 400 is displayed. FIG. 7B shows a state in which a mark 401 is displayed in addition to first moving image 400. FIG. 7C shows a state in which a second moving image 403 is displayed. In the state in which first moving image 400 is displayed as shown in FIG. 7A a prescribed time before the insertion location, the screen in the state shown in FIG. 7B appears. Then, if the user inputs an operation of designating mark 401 before the insertion location of the first moving image is reproduced, the second moving image shown in FIG. 7C appears.

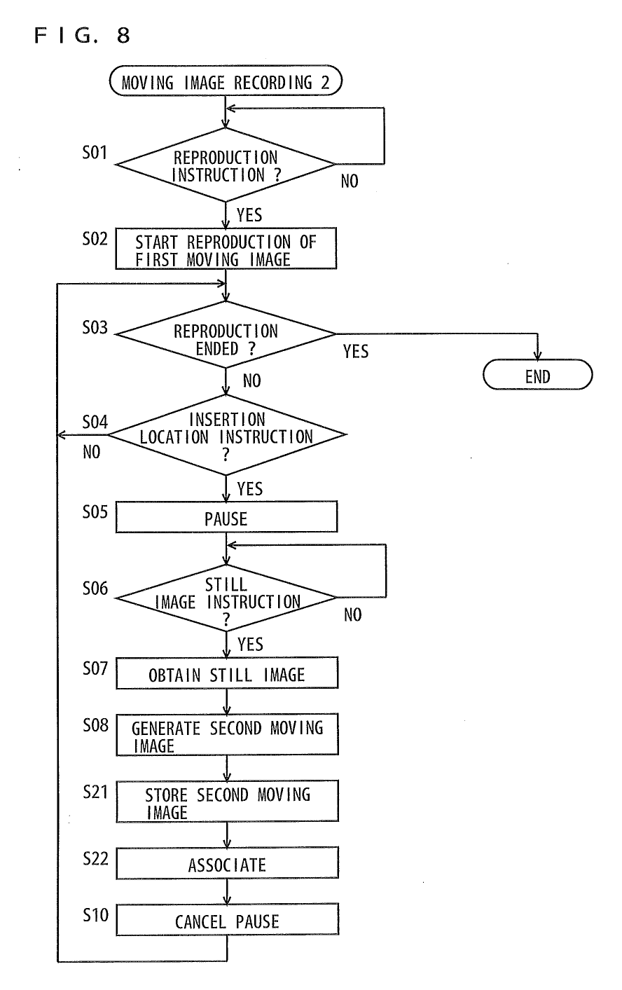

FIG. 8 is a flowchart showing an exemplary flow of a moving image recording process in the modified embodiment. The moving image recording process is a process executed by CPU 111A when CPU 111A of MFP 100A in the modified embodiment executes a moving image recording/reproducing program. The difference from the moving image recording process shown in FIG. 5 is in that step S21 and step S22 are executed in place of step S09 and step S11 is deleted. The other processes are the same as shown in FIG. 5 and therefore a description thereof will not be repeated here.

In step S08, the second moving image is generated, and then in step S21, the second moving image is stored in HDD 116. In the next step S22, the second moving image is associated with the insertion location of the first moving image stored in HDD 116, and the process then proceeds to step S10. Specifically, the insertion location (reproduction time) and the moving image identification information of the second moving image are added to the header of the first moving image stored in HDD 116.

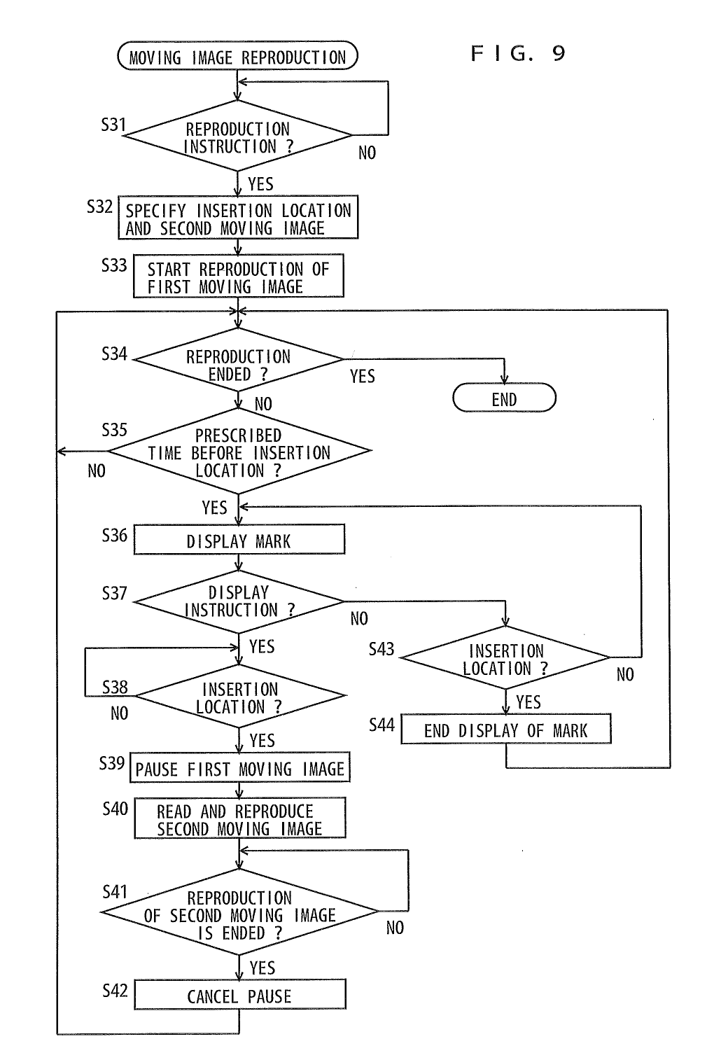

FIG. 9 is a flowchart showing an exemplary flow of a moving image reproduction process. The moving image reproduction process is a process executed by CPU 111A when CPU 111A of MFP 100A in the modified embodiment executes a moving image recording/reproducing program. Referring to FIG. 9, CPU 111A determines whether a reproduction instruction is accepted or not (step S31). The reproduction instruction input to operation portion 160B by the user is accepted. The process waits until a reproduction instruction is accepted (step S31), and if a reproduction instruction is accepted, the process proceeds to step S32. In other words, the moving image recording process is a process executed on condition that moving image 91 is reproduced. Here, moving image 91 selected by the user is referred to as the first moving image. It is noted that the first moving image selected by the user is not limited to moving image 91 stored in HDD 116 and may be a moving image stored in file server 250.

In step S32, the insertion location and the moving image identification information of the second moving image are obtained from the header portion of the first moving image so that the insertion location of the first moving image and the second moving image are specified. Then, the first moving image specified by the moving image identification information included in the reproduction instruction accepted in step S01 is read among from moving images 91 stored in HDD 116 and starts to be reproduced. Then, it is determined whether the reproduction of the first moving image is ended or not (step S34). If the reproduction is ended, the process ends. If not, the process proceeds to step S35.

In step S35, it is determined whether or not the reproduction time of the first moving image is a prescribed time before the insertion location. If it is a prescribed time before the insertion location, the process proceeds to step S36. If not, the process returns to step S34. In step S36, a mark is displayed in order to notify the user of the presence of the second moving image. Then, it is determined whether a display instruction, which is an instruction to reproduce the second moving image, is accepted or not (step S37). The display instruction input to operation portion 160B by the user is accepted. If a display instruction is accepted, the process proceeds to step S38, and if not, the process proceeds to step S43. In step S43, it is determined whether the reproduction time of the first moving image has come to the insertion location. If the reproduction time of the first moving image is the insertion location, the process proceeds to step S44. If not, the process returns to step S36. In step S44, the display of the mark is ended, and the process returns to step S34. In other words, if a display instruction is not accepted before the insertion location of the first moving image is reproduced after the mark is displayed, the reproduction of the first moving image is continued without reproducing the second moving image.

On the other hand, in step S38, it is determined whether or not the reproduction time of the first moving image has come to the insertion location. The process waits until the reproduction time of the first moving image comes to the insertion location (NO in step S38) and the reproduction of the first moving image is continued. If the reproduction time of the first moving image has come to the insertion location, the process proceeds to step S39.

In step S39, the reproduction of the first moving image is paused. Then, the second moving image specified in step S32 is read from HDD 116 and reproduced (step S40). In the next step S41, the process waits until the reproduction of the second moving image is ended (NO in step S41) and the reproduction of the second moving image is continued. If the second moving image is ended, the process proceeds to step S42.

In step S42, the pause is cancelled, and the reproduction of the first moving image whose reproduction has been paused is resumed. The process then returns to step S34.

As described above, when an insertion instruction is accepted during reproduction of the first moving image, MFP 100 serving as the moving image recording/reproducing apparatus in the present embodiment determines, as an insertion location, the reproduction location of the first moving image that is being reproduced at that point of time, and generates and stores the third moving image in which the second moving image displaying a still image is inserted at the insertion location. Therefore, any given location in a moving image can be designated as an insertion location, and a moving image displaying a still image can be inserted into the moving image with a simple operation of designating the still image.

When an insertion instruction is accepted during reproduction of the first moving image, MFP 100 in the modified embodiment determines, as an insertion location, a reproduction location of the first moving image that is being reproduced at that point of time, and stores the second moving image displaying a still image in association with the insertion location of the first moving image. Therefore, when the first moving image associated with the second moving image is reproduced, the second moving image can be reproduced at the insertion location.

Furthermore, since the reproduction of the first moving image is paused at the insertion location, the remainder of the first moving image can be reproduced after the reproduction of the second moving image is ended.

In addition, since the reproduction of the first moving image is paused on condition that an operation of a display instruction is accepted between a prescribed time before the insertion location and the insertion location, the user can select whether or not to reproduce the second moving image.

Although MFP 100 has been described as an example of the moving image recording/reproducing apparatus in the foregoing embodiment, it is needless to say that the present invention can be understood as a moving image recording/reproducing method for executing the moving image recording/reproducing process shown in FIG. 5 and FIG. 8 or FIG. 9 and a moving image recording/reproducing program for allowing a computer to execute the moving image recording/reproducing method.

The embodiment disclosed here should be understood as being illustrative rather than being limitative in all respects. The scope of the present invention is shown not in the foregoing description but in the claims, and it is intended that all modifications that come within the meaning and range of equivalence to the claims are embraced here.

1. A moving image recording/reproducing apparatus comprising:
a reproduction portion to reproduce a moving image;
an insertion location determination portion to determine, as an insertion location, a reproduction location of a first moving image that is being reproduced at a point of time when a prescribed instruction is accepted during reproduction of said first moving image by said reproduction portion;
a still image obtaining portion to obtain a still image;
a moving image generation portion to generate a second moving image displaying said obtained still image;
a combination portion to generate a third moving image in which said second moving image is inserted at said determined insertion location of said first moving image; and
a storage portion to store said generated third moving image.

2. The moving image recording/reproducing apparatus according to claim 1, further comprising a voice accepting portion to accept input of voice, wherein
said moving image generation portion generates a moving image including voice accepted by said voice accepting portion, and
if said moving image includes voice, said reproduction portion reproduces the voice.

3. The moving image recording/reproducing apparatus according to claim 1, wherein said still image obtaining portion includes a document scanning portion to scan a document to output a still image.

4. The moving image recording/reproducing apparatus according to claim 1, further comprising a storage portion to store a still image, wherein
said still image obtaining portion further includes
a still image designation accepting portion to accept designation of a still image stored in said storage portion, and
a reading portion to read a still image specified by said accepted designation from said storage portion.

5. A moving image recording/reproducing apparatus comprising:
a reproduction portion to reproduce a moving image;
an insertion location determination portion to determine, as an insertion location, a reproduction location of a first moving image that is being reproduced at a point of time when a prescribed instruction is accepted during reproduction of said first moving image by said reproduction portion;
a still image obtaining portion to obtain a still image;
a moving image generation portion to generate a second moving image displaying said obtained still image; and
a storage portion to store said second moving image in association with said insertion location of said first moving image.

6. The moving image recording/reproducing apparatus according to claim 5, wherein said reproduction portion includes
a pause portion to pause reproduction of said first moving image at said insertion location having said second moving image associated therewith,
an associated moving image reproduction portion to reproduce said second moving image associated with said insertion location while said first moving image is paused, and
a pause cancel portion to resume reproduction of said first moving image that has been paused, after reproduction of said second moving image is ended.

7. The moving image recording/reproducing apparatus according to claim 6, wherein
said reproduction portion further includes a mark display portion to display a prescribed mark a prescribed time before said insertion location having said second moving image associated therewith, and
said pause portion pauses reproduction of said first moving image on condition that a prescribed operation is accepted after display of said prescribed mark.

8. The moving image recording/reproducing apparatus according to claim 5, further comprising a voice accepting portion to accept input of voice, wherein
said moving image generation portion generates a moving image including voice accepted by said voice accepting portion, and
if said moving image includes voice, said reproduction portion reproduces the voice.

9. The moving image recording/reproducing apparatus according to claim 5, wherein said still image obtaining portion includes a document scanning portion to scan a document to output a still image.

10. The moving image recording/reproducing apparatus according to claim 5, further comprising a storage portion to store a still image, wherein
said still image obtaining portion further includes
a still image designation accepting portion to accept designation of a still image stored in said storage portion, and
a reading portion to read a still image specified by said accepted designation from said storage portion.

11. A moving image recording/reproducing method comprising the steps of:
reproducing a moving image;
determining, as an insertion location, a reproduction location of a first moving image that is being reproduced at a point of time when a prescribed instruction is accepted during reproduction of said first moving image in said step of reproducing;
obtaining a still image;
generating a second moving image displaying said obtained still image;
converting said first moving image into a third moving image in which said second moving image is inserted at said determined insertion location; and
storing said third moving image.

12. A moving image recording/reproducing method comprising the steps of:
reproducing a moving image;
determining, as an insertion location, a reproduction location of a first moving image that is being reproduced at a point of time when a prescribed instruction is accepted during reproduction of said first moving image in said step of reproducing;
obtaining a still image;
generating a second moving image displaying said obtained still image; and
storing said second moving image in association with said insertion location of said first moving image.

13. A computer readable recording medium having a moving image recording/reproducing program recorded thereon for allowing a computer to execute the steps of:
reproducing a moving image;
determining, as an insertion location, a reproduction location of a first moving image that is being reproduced at a point of time when a prescribed instruction is accepted during reproduction of said first moving image in said step of reproducing;
obtaining a still image;
generating a second moving image displaying said obtained still image;
converting said first moving image into a third moving image in which said second moving image is inserted at said determined insertion location; and
storing said third moving image.

14. A computer readable recording medium having a moving image recording/reproducing program recorded thereon for allowing a computer to execute the steps of:
reproducing a moving image;
determining, as an insertion location, a reproduction location of a first moving image that is being reproduced at a point of time when a prescribed instruction is accepted during reproduction of said first moving image in said step of reproducing;
obtaining a still image;
generating a second moving image displaying said obtained still image; and
storing said second moving image in association with said insertion location of said first moving image.
